(19) United States
(12) Patent Application Publication
(10) Pub. No.: US 2003/0051759 A1
(43) Pub. Date: Mar. 20, 2003

(54) Eccentric valve

(76) Inventors: Roland Schmidt, Buehl (DE); Gerta Rocklage, Bochum (DE); Dirk Vollmer, Buehl (DE); Nizar Taghouti, Karslruhe (DE); Claude Berling, Drusenheim (FR)

Correspondence Address: Striker Striker & Stenby, 103 East Neck Road, Huntington, NY, 11743, US

(21) Appl. No.: 10/169,021

(22) PCT Filed: Sep. 20, 2001
(86) PCT No.: PCT/DE01/03623

(30) Foreign Application Priority Data
Oct. 30, 2000 (DE) 100 53 850.9

(51) Int. Cl. F16K 1/02

(52) U.S. Cl. 137/862

(57) ABSTRACT

The invention concerns a valve for controlling flow volumes in the heating and cooling system of a motor vehicle comprising a valve housing (12, 112, 212) and a valve chamber (14, 114, 214) from which at least one intake passage (16, 116, 216) and at least one outlet passage (18, 118, 218) branch off, and comprising at least one valve flap (28, 128, 228) that is arranged in the valve chamber (14, 114, 214) and is rotatable around the axis of a shaft (34, 134, 234), which said valve flap has a valve linkage (30, 130, 230) and a valve sealing head (32, 132, 232) that interacts with at least one valve seat (22, 122, 222) of the valve chamber (14, 114, 214).

It is provided, according to the invention, that the shaft (34, 134, 234) of at least one valve flap (28, 128, 228) is arranged eccentrically in the valve chamber (14, 114, 214).

### BACKGROUND OF THE INVENTION

The invention is based on a valve for controlling and regulating the coolant flow volumes in a motor vehicle according to the preamble of the independent claims.

In order to protect the internal combustion engine of a motor vehicle from overheating, and to utilize the heat given off by the internal combustion engine to heat the passenger compartment, a coolant is circulated in vehicles by pumping, which said coolant can absorb the excess heat of the engine and dissipate it to a desired extent. The heating and cooling cycle of a motor vehicle generally comprises various branches, such as a radiator branch, a bypass branch, or a heat exchanger branch. The excess heat of the coolant can be dissipated into the environment via a radiator in the radiator branch. A heat exchanger, on the other hand, makes the heat from the coolant available for heating the passenger compartment. The distribution of the coolant flow into the various branches of the cooling and heating cycle of a motor vehicle is controlled via at least one valve. The desired coolant temperature is adjusted by mixing a cooled and a non-cooled coolant flow. The regulation of the mixing ratio between the radiator branch and the bypass branch has therefore usually taken place up to now by means of an expansion-element-operated thermostat valve reacting to the coolant temperature.

Due to the principle involved, only one defined mixing temperature for the coolant can be adjusted using this technique, which said temperature is independent of the load situation of the internal combustion engine. The long reaction times of such a thermostat valve represent a disadvantage of this control technique which is not to be disregarded; it can have a negative effect on the optimal temperature equalization of the engine. For the desired temperature equalization of an internal combustion engine, different coolant temperatures—which correspond to the respective load situation of the engine—and short control times in the cooling cycles are desirable.

A map-based thermostat, which is also state of the art at this time, makes it possible to adjust two temperature levels for the coolant in the heating and cooling system of a motor vehicle.

A heat exchanger in the heating and cooling system can be operated via additionally-employed, electromagnetically-driven pulse valves, as described in DE 197 53 575, for example. The discrete opening behavior of pulse valves leads to discontinuous flow ratios that make a targeted control of the desired mixing ratio difficult. Therefore, the heat flows and the desired temperatures in the other branches of the heating and cooling system can not be controlled to the required extent.

A butterfly valve for the automotive industry is presented in U.S. Pat. No. 4,930,455, which said butterfly valve is controlled by an electric motor. This valve in the form of a flap valve (butterfly valve) controls the relative flow volume through the cooling cycle as a function of an electric control signal that is derived from the coolant temperature in the case described.

The disadvantage of this type of control valve is the fact that, even when the valve is open, parts of the valve flap controlling the flow remain in the flow volume as an obstacle, thereby reducing the flow cross-section. This causes a pressure loss via the valve, which can only be offset by means of increased pump output and, therefore, increased energy expenditure and costs.

Another disadvantage of this valve type is the exact mechanical fit required of the participating components to obtain a good seal of the line cross-section. Although tolerances in production can be offset via an elastic sealant that mediates between the actual valve flap and the line cross-section, the sealant itself is subject to strong variations in terms of its expansion due to the very great temperature differences that can occur in the heating and cooling cycle.

Due to the large contact surface of the sealing element with the line cross-section and, last but not least, for the reasons stated hereinabove, a flap valve of the type described in U.S. Pat. No. 4,930,455 requires an increased adjusting force or greater torques to close and open the valve, which makes a larger drive motor necessary. This increases the costs, the amount of installation space required, and the weight of such a valve.

Due to the relatively great adjusting forces required to actuate a flap valve according to U.S. Pat. No. 4,930,455, the closing cover of the valve and, in particular, the elastic sealant, become very susceptible to wear. This can shorten the service life of such a valve.

The potentially strong extent of contamination of the coolant of a vehicle also negatively influences the seal integrity of a flap valve, so that special measures—as described and claimed in U.S. Pat. No. 4,930,455—must be met in order to remove deposits from the valve region.

“Eccentric valves” are known from process engineering, in which the valve flap is arranged eccentrically to the valve seat. This eccentric arrangement leads to a combined rotary and lifting motion of the valve flap and therefore minimizes the surface contact between the sealing element and the valve seat during the opening and closing of the valve.

Due to its relatively demanding geometry and the combined rotary and lifting motion during opening and closing, an eccentric valve requires that very narrow tolerances be adhered to during production. Apart from the production tolerances, changes in temperature and pressure can lead to leakage in the eccentric valve. These basic disadvantages of an eccentric valve have prevented the use of this principle in the automotive industry up until now.

An eccentric valve from the field of process engineering is described in U.S. Pat. No. 5,186,433, the eccentricity of which is adjustable from the outside. The rotation axis of this valve is supported eccentrically in known fashion and, moreover, can be displaced by means of its rotatable and likewise eccentric bearing. In principle, therefore, a subsequent, individual adjustment of the valve to existing production tolerances, for example, is possible.

A disadvantage of the eccentric valve described in U.S. Pat. No. 5,186,433 is the expensive adjustment of the valve element to the respective variations in the dimensions of the valve, which makes it impossible to use this valve principle for large numbers of pieces. Additionally, an optimal, i.e., rapid and continuous adjustment of the valve element to changed operating conditions is not feasible using the eccentric valve described in U.S. Pat. No. 5,186,433.

### ADVANTAGES OF THE INVENTION

The valve according to the invention having the features of the dependent claims has the advantage of being simple in design and, therefore, very cost-effective, comprising a low sensitivity to wear and a high insensitivity to a fluid that may be highly contaminated. The valve according to the invention therefore ideally fulfills the special requirements of the automotive industry.

Since, due to its combined rotary and lifting motion, the valve flap of the valve according to the invention touches the valve housing only in the valve seat, the principle of the eccentric valve is very insensitive to contamination of the flow volume to be regulated.

The valve flap itself is not clamped between seals and therefore only requires comparably very low adjusting forces, so that the drive of the valve according to the invention can be eliminated, which is cost-effective.

Advantageous further developments and improvements of the valve indicated in claim 1 are possible due to the measures listed in the further claims.

Due to a relative motion of the sealing head of the valve flap compared to the valve linkage, the sealing head can align itself automatically and adjust its position to the valve seat. Tolerances in the angle and distance of the valve flap from the valve seat can therefore be offset and neutralized. This is realized to a particular extent by the use of a two-component valve flap having a joint, in particular a ball-and-socket joint, between the valve sealing head and the valve linkage. With the aid of the ball-and-socket joint, a two-axis moveability of the sealing head in relation to the valve linkage is given, which ensures an optimal—because it is automatic and continuous-compensation of existing tolerance errors to a great extent. In particular, therefore, not only is an automatic adjustment of the seal possible in the case of changes in temperature or pressure, but an automatic readjustment of the valve due to wear and abrasion is also given. This can be realized advantageously in particular when the sealing head is produced out of a wear-resistant material, so that any abrasion that occurs on the softer valve housing can be offset by an automatic adjustment of the position of the sealing head in the valve seat. The functionality of the valve can therefore be retained over a markedly extended service life by selecting suitable material pairings.

A valve sealing head that is designed as a mushroom-shaped valve plate ensures a good adjustment of the valve flap to the valve seat and, therefore an optimal sealing of the valve openings.

The valve seats of the valve can be designed integral with the valve chamber, which represents a further simplification of the design and, therefore, a further reduction in production costs of the valve according to the invention.

Due to the additional use of elastic sealing material for the sealing head of the valve flap or on the side of the valve seat, the seal integrity of the valve openings can be increased, if necessary.

As a result of the special shape of the valve flap of the valve according to the invention and its eccentric mounting in the valve chamber, the flow cross-section is advantageously not blocked in the valve when the valve is in the opened state. The pressure drop via the valve can therefore be reduced, which means the corresponding pump output in the cooling cycle can be designed to be lower. This reduces costs and size of the components involved.

A stabilizing effect of the position of the sealing head in the valve seat results when the flow direction of the fluid in the valve extends from the rotation axis of the valve flap toward the sealing head.

Using the principle of the eccentric valve described, a 2-way valve as well as a 3-way or multiway valve arrangement—as required in the cooling cycle of an automobile—can be realized in simple fashion. A 3-way valve that comprises only one single valve flap for controlling the relative flow rates is feasible. A second valve flap can also be integrated in a 3-way valve, so that the two possible outlets of the valve are controlled by two separate valve flaps.

A particularly simple and advantageous design for the valve according to the invention results when the two valve flaps sit on the same shaft (rotation axis) and are driven by said shaft.

Different radial lengths of valve flaps are possible in a common valve chamber, so that an adaptation of the shape of the valve chamber to special design details can be easily realized.

The shaft that conveys the motion of a valve flap (or multiple valve flaps) can be moved in very precise fashion by means of a control drive in the valve according to the invention. For example, a very accurate control of the valve flaps can be obtained via an electric motor and an interposed gear set. The electric motor, in turn, can be controlled by a control signal derived from the engine temperature, for instance. This makes it possible to exactly adjust the respective flow rates and the resultant coolant temperatures in the heating and cooling system of the vehicle. The reaction and control times of active coolant control can be reduced markedly in this fashion as compared with the possibilities offered by a thermostat valve. The coolant flow can be adjusted to the respective engine load in advantageous fashion, thereby improving the efficiency of the engine.

In order to minimize potential problems with the seal of the shaft driving the valve flaps, it is possible to allow the gear set itself to run in the coolant. The gear set can be accommodated advantageously in the valve housing or in a housing interconnected with the valve. As a result, the number of seals required that are subject to wear is reduced, and the risk that the fluid can escape the system due to valve wear is markedly reduced.

The valve according to the invention can be driven in advantageous fashion by means of a wet-running, brushless electric motor, the rotor of which is surrounded by fluid. As an alternative, a dry-running electric motor can also be used advantageously, however, by using a solenoid-operated coupling.

In this fashion, the number of seals subject to wear can be reduced, or their use can be avoided completely. This also reduces the risk that the coolant will leak. Likewise, such an embodiment of the valve according to the invention results in a space-saving, very compact assembly for the control valve.

### SUMMARY OF THE DRAWINGS

Numerous exemplary embodiments of the invention are presented in the drawings, which are explained in greater detail in the subsequent description.

FIG. 1 shows a cross-section through the valve chamber of a first exemplary embodiment of the valve according to the invention with valve flap in place, in the case of a closed valve position,

FIG. 2 shows a further cross-section through the valve chamber of the first exemplary embodiment of the valve according to the invention in the case of an open valve position,

FIG. 3 shows an exemplary embodiment of a valve flap of the valve according to the invention,

FIG. 4 shows a further exemplary embodiment of a valve flap of the valve according to the invention,

FIG. 5 shows a further illustration of the valve flap in FIG. 4,

FIG. 6 shows a cross-section through the valve chamber of a second exemplary embodiment of the valve according to the invention with valve flaps in place, in the case of a closed radiator branch,

FIG. 7 shows a further cross-section through the valve chamber of the second exemplary embodiment of the valve according to the invention with valve flaps in place in the center position,

FIG. 8 shows an outside view of the second exemplary embodiment of the valve according to the invention according to FIGS. 6 and 7, and

FIG. 9 shows a cross-section through a further exemplary embodiment of a valve chamber of the valve according to the invention with valve flaps in place, and an installed gear set for the shaft (rotation axis) of the valve flaps.

### DESCRIPTION OF THE PREFERRED EMBODIMENTS

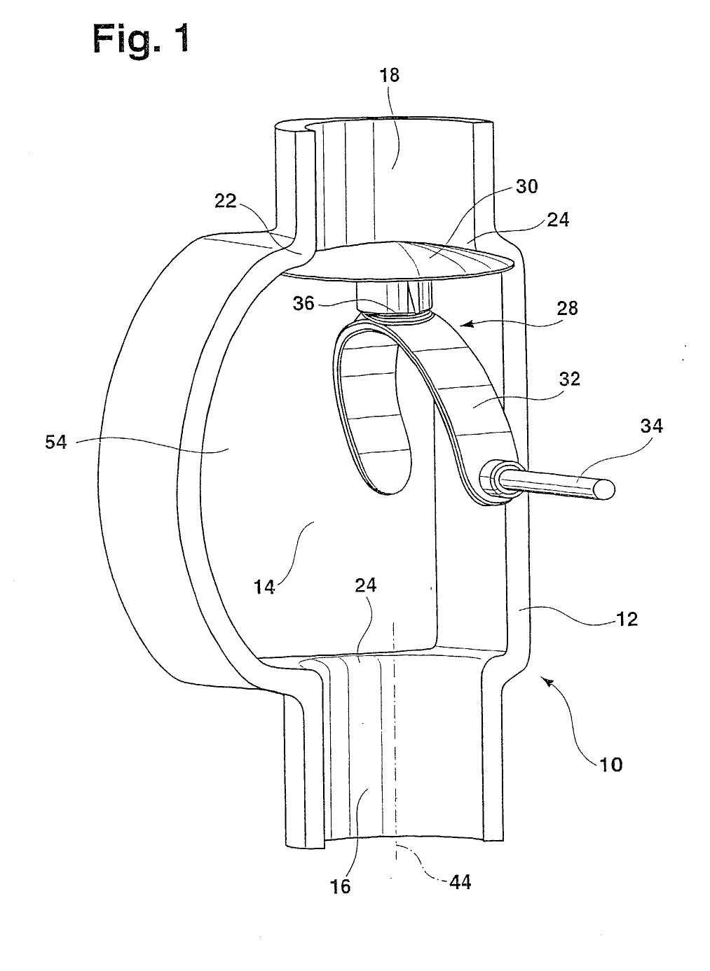

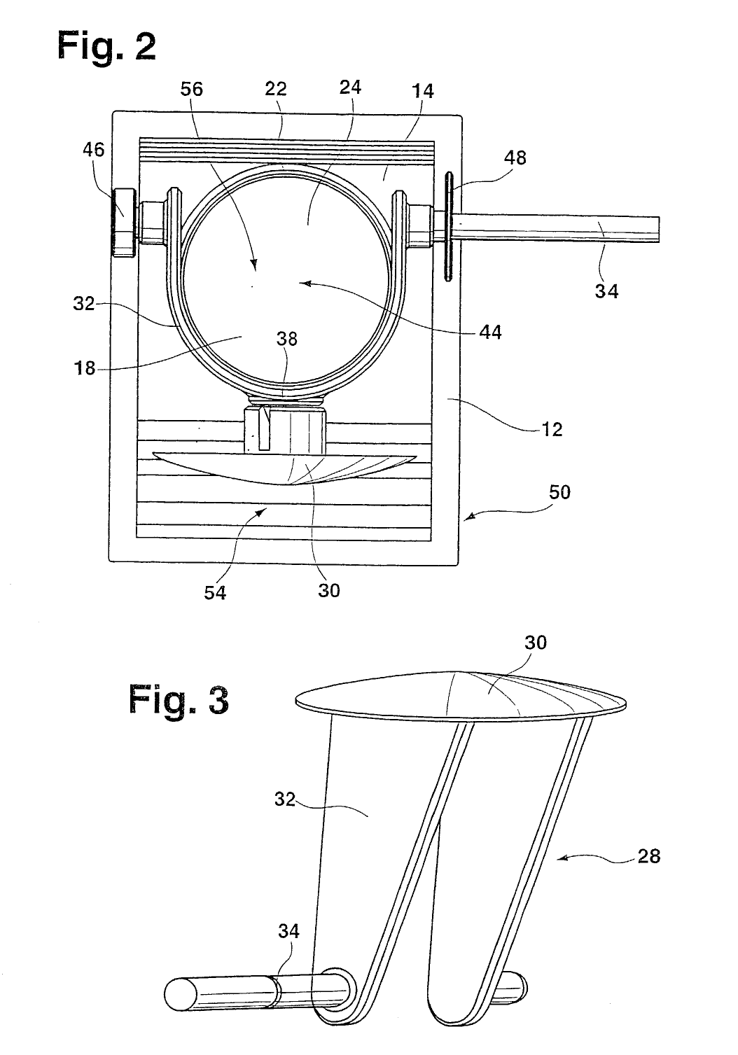

The valve 10, according to the invention, shown in cross-section in FIGS. 1 and 2, comprises a valve housing 12 with a valve chamber 14 into which an intake passage 16 and an outlet passage 18 open. The valve chamber 14 carries a valve seat 22 arranged on the inside, which said valve seat is designed integral with the valve housing 12 in the exemplary embodiment shown. The valve seat 22 surrounds a valve opening 24 that joins the valve chamber 14 with the outlet passage 18.

A valve flap 28 is arranged in the valve chamber 14, which said valve flap can close and open the valve opening 24 in cooperation with the valve seat 22. In the exemplary embodiment shown, the valve flap 28 comprises a valve sealing head 30 and a valve linkage 32 that connects the sealing head 30 with a shaft (rotation axis) 34 of the valve 10.

As shown in FIG. 3, the valve flap 28 can be formed as a single component. It is also possible and advantageous to integrally mould the shaft 34 directly to the valve linkage 32 of the valve flap 28 in the fashion of a crankshaft. In this exemplary embodiment, the valve sealing head 30 has a substantially mushroom-shaped form which, in other exemplary embodiments, can also be a section of a spherical surface or other, appropriately-shaped surfaces. The valve flap 28 can therefore nestle evenly in the valve seat 22 and seal the valve opening 24 well. In order to increase the seal of the valve, it is also possible to provide the valve sealing head 30 or the valve seat 22 with an elastomer.

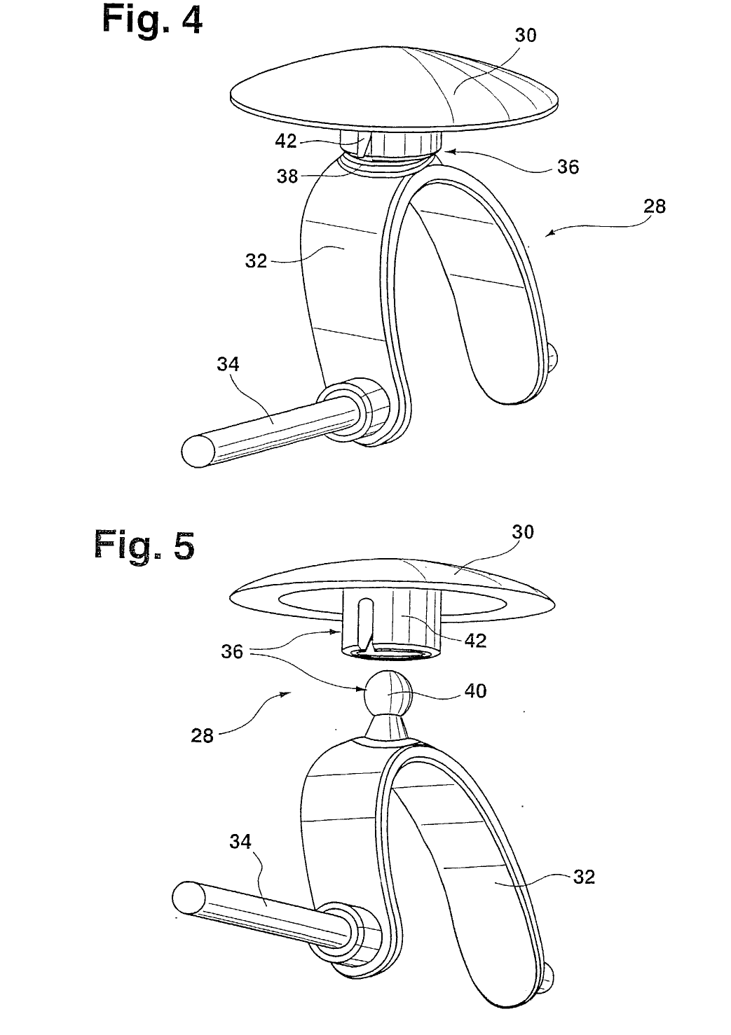

An alternative and advantageous exemplary embodiment of the valve flap 28 of the valve 10 according to the invention is shown in FIGS. 4 and 5. The valve flap 28 in FIGS. 4 and 5 comprises two components and has a joint 36 between the valve linkage 32 and the valve sealing head 30. By means of this joint 36, a relative motion of the sealing head 30 in relation to the valve linkage 32 is possible. Due to this relative motion of the sealing head 30, said sealing head is capable of engaging in a better fit in the valve seat 22 of the valve chamber 14. In simple fashion, the joint 36 also makes an automatic compensation of dimensional variations possible, which said dimensional variations can occur as a result of production and wear of the valve. Such an automatic compensation of production errors or signs of wear is not possible with a rigid valve flap.

The joint 36 shown in FIGS. 4 and 5 is a ball-and-socket joint 38, whereby the ball 40 is designed as part of the valve linkage 32, and the socket 42 is designed as part of the sealing head 30. In the exemplary embodiment in FIG. 4, the ball 40 is clipped into the socket 42. The reverse arrangement is also feasible, of course, in which the valve sealing head 30 carries the ball, and the socket is part of the valve linkage 32.

The valve sealing head 30 is interconnected with the rotation axis 34 via the valve linkage 32. The rotation axis 34 of the valve flap 28 of the valve 10 according to the invention is situated eccentrically in the valve chamber 14: it is obvious in FIG. 2 that the rotation axis 34 of the valve flap 28 extends off-center in relation to the longitudinal axis 44 of the valve openings 24 and 26.

As shown in FIG. 2, the eccentric shaft 34 runs in two bearings 46 and 48 that are anchored in the housing 12 of the valve chamber 14 in the exemplary embodiment shown. The shaft 34 (rotation axis) extends out of the valve housing 12 on one side 50 of the valve chamber 14. Using an appropriate adjusting mechanism 52 that can be attached to the shaft 34—but which is not shown in FIG. 2—the valve flap 28 is rotatable in the valve chamber 14 via the shaft 34. When the valve is opened, the valve flap 28 is rotated out of the flow direction (longitudinal axis 44 in FIGS. 1 and 2) by rotating the shaft 34, and it is rotated in an expanded region 54 of the valve chamber, the cross-section of which is markedly greater than the intake and outlet passage.

FIG. 2 shows the valve 10 according to the invention with the outlet passage 18 completely open in a view in the flow direction. The valve sealing head 30 is rotated out of the flow direction and is located in the expanded region 54 of the valve chamber 14. The valve linkage 32, which connects the sealing head 30 with the shaft 34, is shaped, in the exemplary embodiment shown, in such a fashion that the flow cross-section is not blocked by the valve flap 28 and, in particular, not by the valve linkage 32. For this reason, the shaft 34 is also interrupted in the depicted exemplary embodiment of the valve 10 according to the invention. It is obvious that the valve flap 28 exposes the entire line cross-section 56 of the outlet passage 18, and the flow is not redirected. Due to the special shape of the valve flap 28 and the eccentric positioning of the shaft 34, the pressure drop via the opened valve 10 is minimized.

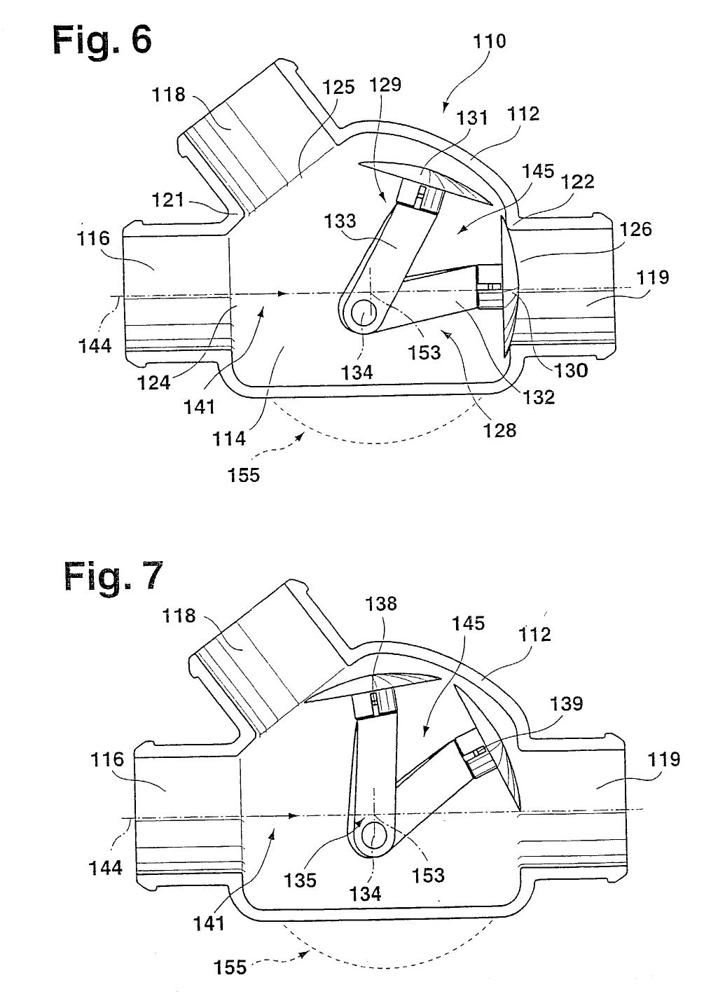

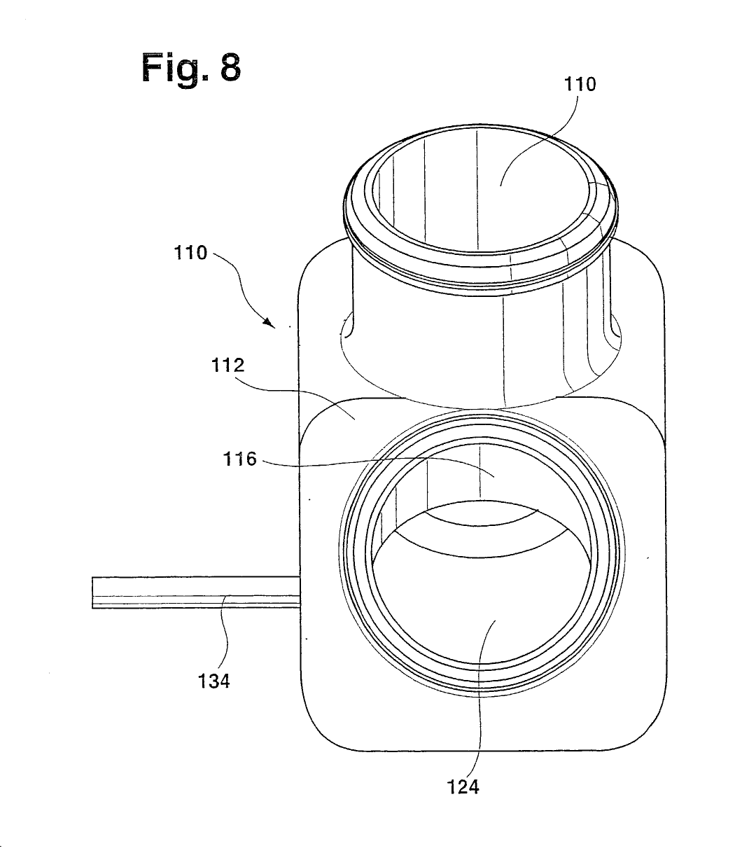

A further exemplary embodiment of the valve according to the invention is shown in FIGS. 6 and 8.

FIG. 6 shows a valve 110 according to the invention having a valve housing 112 and a valve chamber 114 into which an intake passage 116, a first outlet passage 118 and a second outlet passage 119 empty. The valve chamber 114 comprises two valve seats 121 and 122 arranged on the inside, which said valve seats are integrally moulded with the valve housing 112. The valve seats 121 and 122 each surround a valve opening 125 and 126 which connects the valve chamber 114 with the outlet passages 118 and 119. Two valve flaps 128 and 129 are located in the valve chamber 114, which said valve flaps are supported rotatably via a common shaft 134. The radial lengths of the two valve flaps 128 and 129 are equal, so that the intake opening 124 or the outlet openings 125 and 126 lie substantially on the circumference of a circle 155—inscribing the valve chamber 114—with center point 153. The shaft 134 of the valve flaps 128 and 129 is arranged eccentrically in the valve chamber 114, so that the shaft 134 does not intersect the longitudinal axis 144 of the outlet cross-sections, but rather is separated from said longitudinal axis by a distance 135. (The axis of the shaft 134 does not pass through the center point 153 of the circle 155).

The valve flaps 128 and 129 can open and close the valve openings 125 and 126 in interplay with the valve seats 121 and 122. In the exemplary embodiment shown, the valve flaps 128 and 129 each comprise a valve sealing head 130 or 131 and a valve linkage 132 or 133. Valve sealing head 130 and valve linkage 132 or 131 and 133 are interconnected in each case, as described extensively hereinabove, via a ball-and-socket joint 138 or 139 in advantageous fashion.

The exemplary embodiment in FIG. 6 shows the valve 110 according to the invention having a first, completely opened outlet passage 118 and a second, completely closed outlet passage 119. FIG. 7 shows a central position of the valve 110 according to the invention, in which the two outlet passages 118 and 119 are each partially opened. The flow direction in FIGS. 6 and 7 is in the direction of the arrow 141, i.e., from left to right in the drawing.

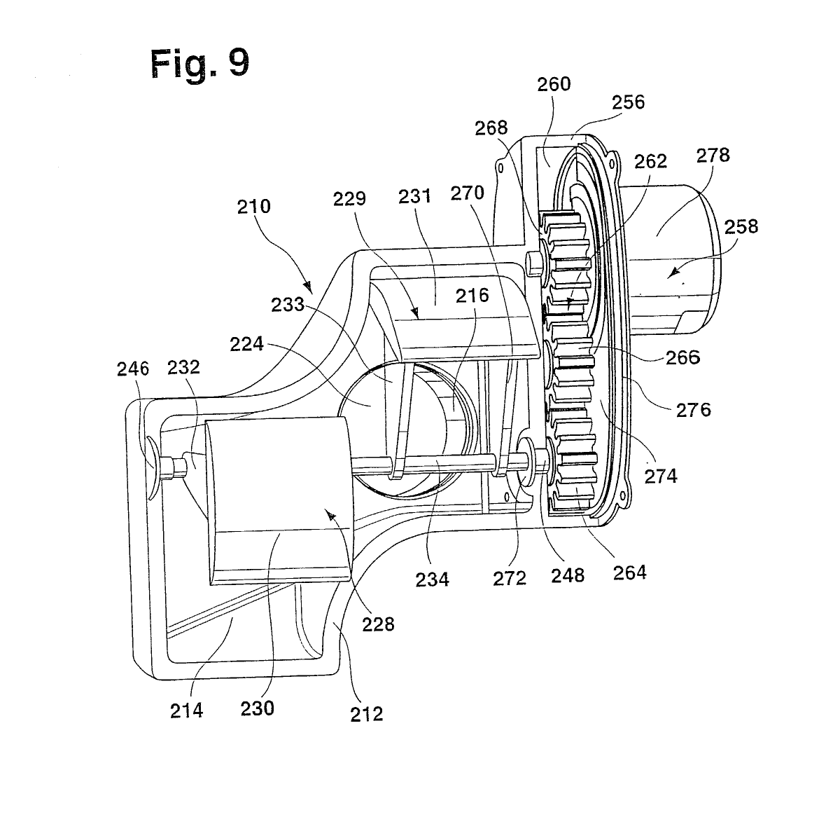

FIG. 8 shows an exterior view of a possible exemplary embodiment of the valve housing 112. The intake opening 124 and the first outlet passage 118 are visible. The second outlet passage 119 is not shown in this perspective illustration. The shaft 134 extending out of the housing is also visible in FIG. 8. In the exemplary embodiments in FIGS. 6 through 8, the two valve flaps 128 and 129 sit on the shaft 134 in the same axial position and are displaced relative to each other only by an angle 145. As a result, the intake passage 116 and the two outlet passages 118 and 119 are in alignment. As another possibility, however, the valve flaps 128 and 129 can be arranged such that the valve flaps are located next to each other, i.e., axially displaced on the shaft 134, as shown in FIG. 9 as well as an example. A further exemplary embodiment of the valve according to the invention is shown in FIG. 9.

The valve 210, according to the invention, shown in FIG. 9 has a valve housing 212 with a valve chamber 214 and an additional gear housing 256, against which an electric motor 258 is installed. A shaft 234 is located in the valve chamber 214, which said shaft is arranged eccentrically to the openings of the valve chamber 214, as described extensively hereinabove. The shaft 234 runs in two bearings 246 and 248 and is continued through the valve housing 212 into a gear space 260 of the gear housing 256. Two valve flaps 228 and 229 sit—axially separated—on the shaft 234 of the valve 210 according to the invention, which said valve flaps each comprise a valve sealing head 230 or 231 and a valve linkage 232 or 233.

The valve flaps 228 and 229 are each developed as single components in the exemplary embodiment shown in FIG. 9. An additional joint 236 or 237 (analogous to FIGS. 4 and 5) between valve linkage 232 and the valve sealing head 230 or 233 and 231 is possible here as well, however.

The valve chamber 214 comprises an intake passage 216 and two outlet passages 218 and 219, of which only the intake passage 216 with the associated valve opening 224 is visible in FIG. 9. The first outlet passage 218 is controlled by the valve flap 229 and, like the second outlet passage 219, is also located on the side of the shaft 234 of the valve housing 214 opposite to the intake passage 216. The outlet passage 218 or the second outlet passage 219 each empty into one valve opening 225 or 226—not shown in FIG. 9—of the valve chamber 212.

The gear housing 256 is designed integral with the valve housing 214 in the depicted exemplary embodiment of the valve 210 according to the invention. A gear set 262 for the driving motor 258 is accommodated in the gear space 260 of the gear housing 256. In the exemplary embodiment, the gear set 262 comprises three gears 264, 266 and 268 that transfer the torque of the electric motor 258 to the shaft 234 of the valve 210 according to the invention. For this purpose, the gear 268 is permanently interconnected with the drive shaft 270 of the electric motor 258. The torque of the electric motor 258 is transferred to the gear 264 with corresponding speed via the idler gear 266, which said gear 264 is also mounted permanently on the rotation axis 234 of the valve 210.

Gear sets other than those shown in FIG. 9 are also feasible for driving the shaft 234.

In the exemplary embodiment shown, the gear space 260 is not sealed off from the valve chamber 214, so that the gear set 262 works in the fluid to be regulated. A split washer 272—which can be manufactured out of rubber or another material—and through which the shaft 234 of the valve 210 extends, keeps coarse dirt particles that can be present in the coolant away from the wet-running gears. If pressure equalization becomes necessary, this can also take place by means of a fine screen or a diaphragm.

The gear space 260 is closed by a housing cover 274 and an O-ring 276 that lies between the gear housing 256 and the housing cover 274 and statically seals the gear space 260.

In the exemplary embodiment shown, the housing cover 274 of the gear housing 256 also carries the electric motor 258 that drives the shaft 234 of the valve 210. In the exemplary embodiment, the housing 278 of the electric motor is designed integral with the housing cover 274 of the gear housing 256. As an alternative, the motor housing 278 can also be attached by means of screwing, riveting, adhesive bonding—or other fastening methods common to one skilled in the art—to the gear housing 256 or another site. The electric motor 258 of the exemplary embodiment shown in FIG. 9 is a brushless DC motor 259 working in the coolant. The rotor (magnet)—not explicitly shown in FIG. 9—of the electric motor 259 is therefore not sealed off from the gear set 262 and the coolant located in the gear space 260.

The invention is not limited to the exemplary embodiments described of an eccentric valve having a maximum of two valve flaps.

It can also be realized advantageously in the case of a valve that has further intake or outlet passages and corresponding valve flaps.

Nor is the valve according to the invention limited to the use of identical radial lengths for the valve flaps. Due to design particulars or other requirements, the valve housing can also be shaped so that the individual valve flaps of a valve have different lengths. This only requires that the extent of the valve chamber be adapted to the length of the valve linkage.

The valve according to the invention is not limited to the use of valve seats designed integral with the valve housing. The shape and material of the valve seats and the valve sealing heads can vary in other exemplary embodiments of the valve according to the invention.

By selecting the proper materials, it can be achieved that material wear or abrasion that may occur at the valve seats is compensated by the automatic adjustment of the orientation of the valve sealing head.

The valve according to the invention is not limited to the use of a ball-and-socket joint between the valve linkage and the valve sealing head. Other joint types common to one skilled in the art are also feasible.

Nor is the valve according to the invention limited to the use of the gear set shown. A gear set comprising worm screw and worm gear is also feasible for the valve according to the invention, as are other gear-set types known to one skilled in the art.

The valve according to the invention is not limited to the use of a wet-running, brushless electric motor. The electric motor can also be sealed off completely from the gear set and the valve chamber, so that the use of other drive systems for the valve is also possible. In particular, a dry-running electric motor can be used advantageously by using a solenoid-operated coupling.

Nor is the valve according to the invention limited to the use of a gear set, in particular a wet-running gear set.

What is claimed is:

1. A valve for controlling flow volumes in the heating and cooling system of a motor vehicle comprising a valve housing (12, 112, 212) and a valve chamber (14, 114, 214) from which at least one intake passage (16, 116, 216) and at least one outlet passage (18, 118, 218) branch off, and comprising at least one valve flap (28, 128, 228) that is arranged in the valve chamber (14, 114, 214) and is rotatable around the axis of a shaft (34, 134, 234), which said valve flap has a valve linkage (30, 130, 230) and a valve sealing head (32, 132, 232) that interacts with at least one valve seat (22, 122, 222) of the valve chamber (14, 114, 214),
wherein the shaft (34, 134, 234) of at least one valve flap (28, 128, 228) is arranged eccentrically in the valve chamber (14, 114, 214).

2. The valve according to claim 1,
wherein the valve sealing head (32, 132, 232) of the at least one valve flap (28, 128, 228) is moveable in relation to its valve linkage (30, 130, 230).

3. The valve according to claim 1,
wherein the valve sealing head (32, 132, 232) of the at least one valve flap (28, 128, 228) is interconnected with the valve linkage (30, 130, 230) via a joint (36, 136, 236).

4. The valve according to claim 1,
wherein the valve flap (28, 128, 228) comprises at least two components.

5. The valve according to claim 3 or 4,
wherein a ball-and-socket joint (38, 138) connects two parts of the valve flap (28, 128, 228) with each other.

6. The valve according to one of the preceding claims,
wherein the valve sealing head (32, 132, 232) of the valve flap (28, 128, 228) is formed by a substantially mushroom-shaped valve plate.

7. The valve according to one of the preceding claims,
wherein the at least one valve seat (22, 122, 222) is designed integral with the valve chamber (14, 114, 214).

8. The valve according to claim 6,
wherein the valve sealing head (32, 132, 232) of the valve flap (28, 128, 228) and/or the valve seat (22, 122, 222) of the valve chamber (14, 114, 214) comprise additional, elastic sealing materials to seal the valve (10, 110, 210).

9. The valve according to one of the preceding claims,
wherein the flow direction of the coolant flow volumes in the valve extends from the shaft (34, 134, 234) of the valve flap (28, 128, 228) toward the valve sealing head (32, 132, 232).

10. The valve according to one of the preceding claims,
wherein the valve linkage (32, 132, 232) and/or the valve chamber (14, 114, 214) are formed in such a manner that, when the valve (10, 110, 210) is open, the flow cross-section is not blocked in the valve chamber (14, 114, 214).

11. The valve according to one of the preceding claims,
wherein the valve chamber (14, 114, 214) has a second outlet passage (119, 219) with associated valve seat (21, 121, 221).

12. The valve according to claim 11,
wherein a second valve flap (29, 129, 229) is present in the valve chamber (14, 114, 214).

13. The valve according to claim 12,
wherein the valve flaps (28, 128, 228; 29, 129, 229) present in the valve chamber (14, 114, 214) sit on a common shaft (34, 134, 234) and are rotatable around the axis of this shaft (34, 134, 234).

14. The valve according to claim 12,
wherein the valve flaps (28, 128, 228; 29, 129, 229) present in the valve chamber (14, 114, 214) have the same radial lengths.

15. The valve according to one of the preceding claims,
wherein the shaft (34, 134, 234) of the at least one valve flap (28, 128, 228; 29, 129, 229) extends out of the valve chamber (14, 114, 214).

16. The valve according to one of the preceding claims,
wherein the shaft (34, 134, 234) of the at least one valve flap (28, 128, 228; 29, 129, 229) is moveable via a control drive (52, 152, 252).

17. The valve according to claim 16,
wherein the control drive (52, 152, 252) comprises an electric motor (258) and a gear set (262).

18. The valve according to claim 17,
wherein the gear set (262) is awash in the flow volume to be regulated.

19. A valve for controlling flow volumes in the heating and cooling system of a motor vehicle comprising a valve housing (12, 112, 212) and a valve chamber (14, 114, 214) having at least one intake passage (16, 116, 216) and at least one outlet passage (18, 118, 218) branching off from it, and comprising at least one valve flap (28, 128, 228) that is arranged in the valve chamber (14, 114, 214) and is rotatable around the axis of a shaft (34, 134, 234), which said valve flap has a valve linkage (30, 130, 230) and a valve sealing head (32, 132, 232) that interacts with at least one valve seat (22, 122, 222) of the valve chamber (14, 114, 214),
wherein the valve (10, 110, 210) is an eccentric valve that comprises a joint (36, 136) between the valve linkage (30, 130, 230) and the valve sealing head (32, 132, 232).

20. A valve for controlling flow volumes in the heating and cooling system of a motor vehicle comprising a valve housing (12, 112, 212) and a valve chamber (14, 114, 214) having at least one intake passage (16, 116, 216) and at least one outlet passage (18, 118, 218) branching off from it, and comprising at least one valve flap (28, 128, 228) that is arranged in the valve chamber (14, 114, 214) and is rotatable around the axis of a shaft (34, 134, 234), which said valve flap has a valve linkage (30, 130, 230) and a valve sealing head (32, 132, 232) that interacts with at least one valve seat (22, 122, 222) of the valve chamber (14, 114, 214),
wherein the rotation axis (34, 134, 234) of the at least one valve flap (28, 128, 228; 29, 129, 229) is supported eccentrically and is moveable via a gear set (262) that is awash in the fluid to be regulated.

21. The valve according to claim 17 or 20,
wherein the gear set (262) is driven by a brushless DC motor, the rotor of which runs in the coolant to be regulated.
